(19) United States
(12) Patent Application Publication
(10) Pub. No.: US 2019/0024025 A1
(43) Pub. Date: Jan. 24, 2019

(54) MICROCAPSULE

(71) Applicant: Conopco, Inc. d/b/a UNILEVER, Englewood Cliffs, NJ (US)

(72) Inventors: Craig Warren JONES, Prenton, Wirral (GB); Changxi LI, Shanghai (CN); Xiaoyun PAN, Shanghai (CN); Yan WU, Shanghai (CN); Yuanyuan ZHANG, Shanghai (CN)

(73) Assignee: Conopco, Inc. d/b/a UNILEVER, Englewood Cliffs, NJ (US)

(21) Appl. No.: 16/064,127

(22) PCT Filed: Dec. 2, 2016
(86) PCT No.: PCT/EP2016/079570

§ 371 Date: Jun. 20, 2018

(30) Foreign Application Priority Data
Dec. 22, 2015 (CN) PCT/CN2015/098331
Feb. 4, 2016 (EP) 16154262.6

(51) Int. Cl. C11D 3/50; C11D 3/12; C11D 3/37; C11D 3/22; C11D 17/00

(52) U.S. Cl. CPC C11D 3/505; C11D 3/124; C11D 3/3723; C11D 17/0039; C11D 3/3769; C11D 3/378; C11D 3/222; C11D 3/3757

(57) ABSTRACT

Disclosed is a microcapsule comprising a benefit agent inside a water insoluble porous inner shell, an outer shell comprising at least one layer of cationic polymer and at least one layer of anionic polymer, and a non-ionic polysaccharide deposition aid.

### FIELD OF THE INVENTION

The present invention is concerned with microcapsule comprising benefit agents to substrates, processes for manufacture of the microcapsule, and composition comprising such microcapsule. Such particle may deliver enhanced fragrance at early freshness moments to consumers, in particular when clothes were taken out from washing machine.

### BACKGROUND OF THE INVENTION

Many home care and personal care products seek to deliver benefit agents to substrates such as textiles, hard surfaces, hair and skin. To achieve a long-lasting benefit agent release performance, encapsulation of the benefit agent in particles has been proposed as a means, in particular for the perfume. When applied, the microcapsule may be deposition onto the substrates, for example onto clothes, and broken by action of pressure and/or rubbing when consumers get dressed. The perfume is released and brings superior sensory to the consumers.

However, another important moment to the consumer at least for laundry products is the moment when the garments are being taken out from the washing machine. It is desirable to release perfume to please the consumer at this moment. Such performance would not be achieved to add fragrance into detergents without encapsulation because the fragrance will be washed away during the rinse cycle.

Thus, we have recognized a need for microcapsule which is capable of being encapsulated when the microcapsules are in laundry composition but being deposited onto the textile and releasing the benefit agent during washing and/or conditioning process.

Therefore, we developed a microcapsule comprising a benefit agent inside a water insoluble porous inner shell, an outer shell comprising at least one layer of cationic polymer and at least one layer of anionic polymer and a non-ionic polysaccharide deposition aid. It was surprisingly found that when included into laundry composition, the benefit agent was encapsulated into the microcapsules and the benefit agent is capable of being released by action of diluting the laundry composition, which is a simulation of washing and/or condition process.

### SUMMARY OF THE INVENTION

In a first aspect, the present invention is directed to a microcapsule comprising a benefit agent inside a water insoluble porous inner shell, an outer shell comprising at least one layer of cationic polymer and at least one layer of anionic polymer, and a non-ionic polysaccharide deposition aid.

In a second aspect, the present invention is directed to a process for the production of microcapsule of the present invention, the process comprising: i) encapsulating the benefit agent into a water insoluble porous inner shell; iii) attaching a non-ionic polysaccharide deposition aid onto the microcapsule; iii) forming a cationic polymer layer and an anionic polymer layer without a step of separation; and optionally repeating step (iii) without a step of separation.

In a third aspect, the present invention is directed to a laundry composition comprising microcapsule of the present invention, and at least one surfactant.

All other aspects of the present invention will more readily become apparent upon considering the detailed description and examples which follow.

### DETAILED DESCRIPTION OF THE INVENTION

Except in the examples, or where otherwise explicitly indicated, all numbers in this description indicating amounts of material or conditions of reaction, physical properties of materials and/or use may optionally be understood as modified by the word “about”.

All amounts are by weight of the composition, unless otherwise specified.

It should be noted that in specifying any range of values, any particular upper value can be associated with any particular lower value.

For the avoidance of doubt, the word “comprising” is intended to mean “including” but not necessarily “consisting of” or “composed of”. In other words, the listed steps or options need not be exhaustive.

The disclosure of the invention as found herein is to be considered to cover all embodiments as found in the claims as being multiply dependent upon each other irrespective of the fact that claims may be found without multiple dependency or redundancy.

“Size” as used herein refers to diameter unless otherwise stated. For samples having particulate with diameter no greater than 1 μm, diameter means the z-average microcapsule size measured, for example, using dynamic light scattering (see international standard ISO 13321) with an instrument such as a Zetasizer Nano™ (Malvern Instruments Ltd, UK). For samples having particulate with diameter greater than 1 μm, diameter means the apparent volume median diameter (D50, also known as x50 or sometimes d(0.5)) of the microcapsules measurable for example, by laser diffraction using a system (such as a Mastersizer™ 2000 available from Malvern Instruments Ltd) meeting the requirements set out in ISO 13320.

“Water insoluble” as used herein refers to that the solubility in water is less than 1 gram per 100 gram of water, preferably less than 1 gram per 1 kilogram of water at 25° C. and at atmospheric pressure.

Typically, the microcapsule has an average size of from 0.6 to 40 μm. More preferably the microcapsule has an average size of 2 to 32 μm, even more preferably from 4 to 25 μm and most preferably from 6 to 20 μm.

Benefit agents according to the present invention refers to agents which may provide a range of benefits to skin and/or fabrics, more preferably to fabrics and most preferably to cellulosics fabrics, polyesters fabrics or a combination thereof. The benefit agent is typically present in an amount of from 10-90% by total weight of the microcapsule, more preferably from 15 to 60% by total weight of the microcapsule.

The benefit agents may include fragrance, pro-fragrance, enzymes, antifoams, fluorescers, shading dyes, pigments, antimicrobial agents, or a mixture thereof. More preferably, the benefit agent comprises fragrance and/or pro-fragrance, and most preferably the benefit agent is fragrance.

Useful components of the fragrance include materials of both natural and synthetic origin. They include single compounds and mixtures. Specific examples of such components may be found in the current literature, e.g., in Fenaroli's Handbook of Flavour Ingredients, 1975, CRC Press; Synthetic Food Adjuncts, 1947 by M. B. Jacobs, edited by Van Nostrand; or Fragrance and Flavour Chemicals by S. Arctander 1969, Montclair, N.J. (USA). These substances are well known to the person skilled in the art of perfuming, flavouring, and/or aromatizing consumer products, i.e., of imparting an odour and/or a flavour or taste to a consumer product traditionally fragranced or flavoured, or of modifying the odour and/or taste of said consumer product.

By fragrance in this context is not only meant a fully formulated product fragrance, but also selected components of that fragrance, particularly those which are prone to loss, such as the so-called ‘top notes’.

Top notes are defined by Poucher (Journal of the Society of Cosmetic Chemists 6(2):80 [1955]). Examples of well known top-notes include citrus oils, linalool, linalyl acetate, lavender, dihydromyrcenol, rose oxide and cis-3-hexanol. Top notes typically comprise 15-25% wt of a fragrance composition and in those embodiments of the invention which contain an increased level of top-notes it is envisaged at that least 20% wt would be present within the microcapsule.

Another group of fragrances with which the present invention can be applied are the so-called ‘aromatherapy’ materials. These include many components also used in fragrancery, including components of essential oils such as Clary Sage, Eucalyptus, Geranium, Lavender, Mace Extract, Neroli, Nutmeg, Spearmint, Sweet Violet Leaf and Valerian.

Typical fragrance components which it is advantageous to employ in the embodiments of the present invention include those with a relatively low boiling point, preferably those with a boiling point of less than 300, preferably 100-250 Celsius, measured at one atmosphere.

It is also advantageous to encapsulate fragrance components which have a low Log P (i.e. those which will be partitioned into water), preferably with a Log P of less than 3.0.

The pro-fragrance can, for example, be a food lipid. Food lipids typically contain structural units with pronounced hydrophobicity. The majority of lipids are derived from fatty acids. In these ‘acyl’ lipids the fatty acids are predominantly present as esters and include mono-, di-, triacyl glycerols, phospholipids, glycolipids, diol lipids, waxes, sterol esters and tocopherols.

The fragrance is typically present in an amount of from 10-85% by total weight of the microcapsule, preferably from 15 to 75% by total weight of the microcapsule. The fragrance suitably has a molecular weight of from 50 to 500 Dalton. Pro-fragrances can be of higher molecular weight, being typically 1-10 kD.

For the sake of clarity, it should be explained that the water insoluble porous inner shell forms a hollow core inside of the inner shell and the microcapsule comprise the benefit agent at least in the hollow core. The pore used herein refers to the pore on the wall of the inner shell instead of the hollow core formed by the porous inner shell.

Preferably, the core comprises at least 5% of fragrance by weight of the core, more preferably from 10% to 100% by weight of the core, even more preferably from 35% to 100% by weight of the core.

Typically, the pore of the inner shell has an average size of 5 nm to 800 nm, more preferably from 12 nm to 400 nm, even more preferably from 30 to 200 nm. Size of the pore means the largest measurable distance on the pore. The average size may be measured for example by scanning electron microscopy (SEM) by averaging the value of at least ten pores.

The inner shell may comprise inorganic material, polymer, or a mixture thereof. Inorganic material may be selected from clay, zeolite, silica, amorphous silicate, crystalline nonlayer silicate, layer silicate, calcium carbonate, sodium carbonate, sodalite, and alkali metal phosphates. Typically, the polymer may be bio-polymer and/or synthetic polymer. Suitable polymer may comprise derivative of alginate, chitosan, collegen, dextran, gelatin, cellulose, gum, starch, polyvinyl pyrrolidone, polyvinyl alcohol, cellulose ether, polystyrene, polyacrylate, polymethacrylate, polyolefin, aminoplast polymer, polyacrylamide, acrylate-acrylamide copolymer, melamine-formaldehyde condensate, urea-formaldehyde condensate, polyurethane, polysiloxane, polyurea, polyamide, polyimide, polyanhydride, polyolefin, polysulfone, polysaccaharide, polylactide, polyglycolide, polyorthoester, polyphosphazene, silicone, lipid, polyester, ethylene maleic anyhydride copolymer, styrene maleic anyhydride copolymer, ethylene vinyl acetate copolymer, lactide glycolide copolymer, or combinations of these materials.

Preferably, the inner shell comprises polystyrene, polyvinyl alcohol, polyacrylate, polymethacrylates, polyolefins, aminoplast polymer, polyacrylamide, acrylate-acrylamide copolymer, melamine-formaldehyde condensate, urea-formaldehyde condensate, polyurethane, polyurea, polysaccaharide, silica, calcium carbonate, or a mixture thereof. More preferably, the inner shell comprises polystyrene, modified polyvinyl alcohol, polyacrylate, polymethacrylate, polyolefin, aminoplast polymers, melamine-formaldehyde condensate, urea-formaldehyde condensate, polyurethane, polyurea, silica, calcium carbonate, or a mixture thereof. Even more preferably the inner shell comprises melamine-formaldehyde condensate, polystyrene, modified polyvinyl alcohol, polyolefin, polyurethane, polyurea, silica or a mixture thereof. Still even more preferably, the inner shell comprises melamine-formaldehyde condensate, polyurethane, polyurea, silica, modified polyvinyl alcohol, or a mixture thereof and most preferably the inner shell comprises melamine-formaldehyde condensate, silica, or a mixture thereof.

Typically, the cationic polymer is selected from polyallylamine hydrochloride, polyethyleneimine, polyquaternium-48, polyquaternium-49, polyquaternium-50, polyvinylpyrrolidone, poly(L-lysine), chitosan, polydiallyldimethylammonium chloride, polyquaternium-39, and polyhexamethylene biguanidine hydrochloride, more preferably the cationic polymer is selected from polyallylamine hydrochloride, poly(ethyleneimine), polyquaternium-49, poly(L-lysine), poly(diallyldimethylammonium chloride), polyquaternium-39, and polyhexamethylene biguanidine hydrochloride. Even more preferably, the cationic polymer is polyquaternium-49 (PQ-49).

In some embodiments, for example when including the microcapsule into fabric conditioner, it is preferred that the cationic polymer is selected from polyquaternium-48, polyquaternium-50 and polyvinylpyrrolidone.

Preferably, the cationic polymer has a weight average molecular weight of from 10,000 to 400,000, more preferably from 20,000 to 250,000, even more preferably from 30,000 to 120,000 and most preferably from 40,000 to 100,000.

Typically, the anionic polymer is selected from poly-styrenesulfonic acid, heparin, polyacrylic acid, alginate, carboxymethyl cellulose, poly-vinylsulfonic acid, poly-methacrylic acid and Arabic gum. More preferably the anionic polymer is selected from poly-styrenesulfonic acid, heparin, polyacrylic acid, and alginate. Even more preferably the anionic polymer is poly-styrenesulfonic acid.

Preferably the anionic polymer has a weight average molecular weight of from 10,000 to 300,000, more preferably from 15,000 to 180,000, even more preferably from 30,000 to 120,000 and most preferably from 40,000 to 100,000.

Most preferably, the cationic polymer is polyquaternium-49 and the anionic polymer is poly-styrenesulfonic acid. Preferably both polyquaternium-49 and poly-styrenesulfonic acid have an weight average molecular weight of from 40,000 to 100,000.

Preferably, the outer shell comprises 1 to 10 layers of cationic polymer and 1 to 10 layers of anionic polymer. More preferably the outer shell comprises 1 to 4 layers of cationic polymer and 1 to 4 layers of anionic polymer and most preferably the outer shell comprises 2 to 3 layers of cationic polymer and 2 to 3 layers of anionic polymer. Preferably, the layer of the anionic polymer is same as the layer of cationic layer.

Preferred polysaccharide deposition polymers may be selected from the group consisting of: tamarind gum (preferably consisting of xyloglucan polymers), guar gum, locust bean gum (preferably consisting of galactomannan polymers), and other industrial gums and polymers, which include, but are not limited to, Tara, Fenugreek, Aloe, Chia, Flaxseed, Psyllium seed, quince seed, xanthan, gellan, welan, rhamsan, dextran, curdlan, pullulan, scleroglucan, schizophyllan, chitin, hydroxyalkyl cellulose, arabinan (preferably from sugar beets), de-branched arabinan (preferably from sugar beets), arabinoxylan (preferably from rye and wheat flour), galactan (preferably from lupin and potatoes), pectic galactan (preferably from potatoes), galactomannan (preferably from carob, and including both low and high viscosities), glucomannan, lichenan (preferably from icelandic moss), mannan (preferably from ivory nuts), pachyman, rhamnogalacturonan, acacia gum, agar, alginates, carrageenan, chitosan, clavan, hyaluronic acid, heparin, inulin, cellodextrins, cellulose, cellulose derivatives and mixtures thereof.

Preferably the polysaccharide is a cellulose, a cellulose derivative, or another ß-1,4-linked polysaccharide having an affinity for cellulose, preferably mannan, glucan, glucomannan, xyloglucan, galactomannan and mixtures thereof. More preferably, the polysaccharide is selected from the group consisting of xyloglucan and galactomannan. Most preferably, the deposition polymer is locust bean gum, xyloglucan, guar gum or mixtures thereof.

Alternatively or additionally, the polysaccharides may be selected from the group consisting of hydroxyl-propyl cellulose, hydroxy-propyl methyl cellulose, hydroxy-ethyl methyl cellulose, hydroxy-propyl guar, hydroxy-ethyl ethyl cellulose and methyl cellulose.

Preferably, the polysaccharide have only ß-1,4 linkages in the polymer backbone.

The preferred molecular weight of the polysaccharide deposition aid is in the range of from about 5 kDa to about 500 kDa, preferably 10 kDa to 500 kDa, more preferably 20 kDa to 300 kDa. Preferably, the deposition aid is present at levels such that the ratio of polymer:microcapsule solids is in the range 1:500 to 3:1, preferably 1:200 to 1:3.

The deposition aid is preferably bonded to the inner shell, more preferably by means a covalent bond, entanglement and/or strong adsorption, even more preferably by a covalent bond and/or entanglement, and most preferably by means of covalent bond and entanglement. It is important that the deposition aid is not be removed by water from the microcapsule as it cannot then function effectively as a delivery aid. Entanglement as used herein refers to that the deposition aid is adsorbed onto the microcapsule as the polymerization proceeds and the microcapsule grows in size. It is believed that under such circumstances part of the adsorbed deposition aid becomes buried within the interior of the microcapsule. Hence at the end of the polymerization, part of the deposition aid is entrapped and bound in the polymer matrix of the microcapsule, whilst the remainder is free to extend into the aqueous phase.

The microcapsule may be prepared in any suitable process. However, it is preferred that the process comprises:
i) encapsulating the benefit agent inside a water insoluble porous inner shell;
ii) attaching a non-ionic polysaccharide deposition aid onto the microcapsule;
iii) forming a cationic polymer layer and an anionic polymer layer without a step of separation; and
optionally repeating step (iii) without a step of separation.

In step i), the benefit agent may be encapsulated when the capsule having the inner shell is formed. Alternatively, the capsules having the inner shell can be formed which does not contain the benefit agent (hollow porous capsule) and subsequently exposed them to a benefit agent which can be adsorbed inside the hollow core.

It is preferred that the cationic polymer is formed first in the event that the porous shell is negatively charged and vice versa. Then, an polymer layer with opposite charge may be formed after the formation of the first polymer layer. When forming a layer of polymer, the polymer is preferably in the form of aqueous solution. For sake of clarity, without a step of separation refers to there is no step of separation between the formation of opposite charged polymers layers.

The end-product compositions of the invention may be in any physical form but preferably an aqueous-based liquid. The microcapsules of the invention may be advantageously incorporated into laundry and/or personal care compositions, but preferably into a laundry composition. The laundry composition is preferably an aqueous laundry detergent or an aqueous fabric conditioner. The personal care composition is preferably a skin cleansing composition containing a cleansing surfactant. Preferably the composition comprises water in an amount of at least 5% by weight of the composition, more preferably at least 15% and even more preferably at least 30% by weight of the composition.

Typically, the laundry or personal care composition comprises the microcapsules at levels of from 0.001% to 10%, more preferably from 0.005% to 7.55%, more preferably from 0.01 to 5%, and most preferably from 0.1% to 2% by weight of the total composition.

The composition preferably comprises a cleansing surfactant, a fabric conditioning compound, or a mixture thereof. More than one cleansing surfactant may be included in the composition. The cleaning surfactant may be chosen from soap, non-soap anionic, cationic, non-ionic, amphoteric and zwitterionic surfactant and mixtures thereof. Many suitable surface active compounds are available and are fully described in the literature, for example, in “Surface-Active Agents and Detergents”, Volumes I and II, by Schwartz, Perry and Berch. The preferred surface-active compounds that can be used are soaps non-soap anionic, non-ionic surfactant, or a mixture thereof.

Suitable non-soap anionic surfactants include linear alkylbenzene sulphonate, primary and secondary alkyl sulphates, particularly C₈ to C₁₅ primary alkyl sulphates; alkyl ether sulphates; olefin sulphonates; alkyl xylene sulphonates; dialkyl sulphosuccinates; fatty acid ester sulphonates; or a mixture thereof. Sodium salts are generally preferred.

Most preferred non-soap anionic surfactant are linear alkylbenzene sulphonate, particularly linear alkylbenzene sulphonates having an alkyl chain length of from C₈ to C₁₅. It is preferred if the level of linear alkylbenzene sulphonate is from 0 wt % to 30 wt %, more preferably from 1 wt % to 25 wt %, most preferably from 2 wt % to 15 wt %, by weight of the total composition.

Nonionic surfactants that may be used include the primary and secondary alcohol ethoxylates, especially the C₈ to C₂₀ aliphatic alcohols ethoxylated with an average of from 1 to 20 moles of ethylene oxide per mole of alcohol, and more especially the C₁₀ to C₁₅ primary and secondary aliphatic alcohols ethoxylated with an average of from 1 to 10 moles of ethylene oxide per mole of alcohol. Non ethoxylated nonionic surfactants include alkylpolyglycosides, glycerol monoethers, and polyhydroxyamides (glucamide). It is preferred if the level of non-ionic surfactant is from 0 wt % to 30 wt %, preferably from 1 wt % to 25 wt %, most preferably from 2 wt % to 15 wt %, by weight of a fully formulated composition comprising the microcapsules of the invention.

It is also possible to include certain mono-alkyl cationic surfactants. Cationic surfactants that may be used include quaternary ammonium salts of the general formula R¹R²R³R⁴N⁺X⁻ wherein the R groups are long or short hydrocarbon chains, typically alkyl, hydroxyalkyl or ethoxylated alkyl groups, and X is a counter-ion (for example, compounds in which R¹ is a C₈-C₂₂ alkyl group, preferably a C₈-C₁₀ or C₁₂-C₁₄ alkyl group, R² is a methyl group, and R³ and R⁴, which may be the same or different, are methyl or hydroxyethyl groups); and cationic esters (for example, choline esters).

Any conventional fabric conditioning compound may be used. The conditioning compound may be cationic or non-ionic. If the fabric conditioning compound is to be employed in a main wash detergent composition the compound will typically be non-ionic. For use in the rinse phase, typically they will be cationic. They may for example be used in amounts from 0.5% to 35%, preferably from 1% to 30% more preferably from 3% to 25% by weight of a fully formulated composition comprising the microcapsules of the invention.

The fabric conditioning compounds are preferably compounds that provide excellent softening, and are characterised by a chain melting Lβ to Lα transition temperature greater than 25 Celsius, preferably greater than 35 Celsius, most preferably greater than 45 Celsius. This Lβ to Lα transition can be measured by differential scanning calorimetry as defined in “Handbook of Lipid Bilayers”, D Marsh, CRC Press, Boca Raton, Fla., 1990 (pages 137 and 337).

Suitable cationic fabric conditioning compounds are substantially water-insoluble quaternary ammonium materials comprising a single alkyl or alkenyl long chain having an average chain length greater than or equal to C₂₀ or, more preferably, compounds comprising a polar head group and two alkyl or alkenyl chains having an average chain length greater than or equal to C₁₄. Preferably the fabric softening compounds have two long chain alkyl or alkenyl chains each having an average chain length greater than or equal to C₁₆. Most preferably at least 50% of the long chain alkyl or alkenyl groups have a chain length of C₁₈ or above. It is preferred if the long chain alkyl or alkenyl groups of the fabric softening compound are predominantly linear. Substantially water-insoluble fabric softening compounds are defined as fabric softening compounds having a solubility of less than 1×10⁻³ wt % in demineralised water at 20 Celsius. Preferably the fabric conditioning agent have a solubility of less than 1×10⁻⁴ wt %, more preferably from less than 1×10⁻⁸ to 1×10⁻⁶ wt %.

Quaternary ammonium compounds having two long-chain aliphatic groups, for example, distearyldimethyl ammonium chloride and di(hardened tallow alkyl) dimethyl ammonium chloride, are widely used in commercially available rinse conditioner compositions.

It is advantageous if the quaternary ammonium material is biologically biodegradable.

Compositions comprising microcapsules according to the invention may also suitably contain a bleach compound. Suitable peroxy bleach compounds include organic peroxides such as urea peroxide, and inorganic persalts such as the alkali metal perborates, percarbonates, perphosphates, persilicates and persulphates. Preferred inorganic persalts are sodium perborate monohydrate and tetrahydrate, and sodium percarbonate. Especially preferred bleach compound is sodium percarbonate, preferably having a protective coating against destabilisation by moisture.

The peroxy bleach compound is suitably present in a fully formulated product in an amount of from 0.1 to 35 wt %, preferably from 0.5 to 25 wt %.

The fully formulated compositions may also contain one or more enzyme(s).

Suitable enzymes include the proteases, amylases, cellulases, oxidases, peroxidases and lipases usable for incorporation in detergent compositions. Preferred proteolytic enzymes (proteases) are, catalytically active protein materials which degrade or alter protein types of stains when present as in fabric stains in a hydrolysis reaction. They may be of any suitable origin, such as vegetable, animal, bacterial or yeast origin.

The compositions of the invention may contain alkali metal, preferably sodium carbonate, in order to increase detergency and ease processing. Sodium carbonate may suitably be present in fully formulated products in amounts ranging from 1 to 60 wt %, preferably from 2 to 40 wt %.

The fully formulated detergent composition when diluted in the wash liquor (during a typical wash cycle) will typically give a pH of the wash liquor from 7 to 10.5 for a main wash detergent.

The invention will now be described with reference to the following non-limiting examples.

### EXAMPLES

### Materials

TABLE 1
cationic polymers and anionic polymers

| Polymer name | Abbreviation | Supplier |
|---|---|---|
| Poly(allylaminehydrochloride) | PAH | Aldrich |
| Poly(ethyleneimine) (molecule weight | PEI | BASF |
| 750k) | | |
| Poyquaternium-48 | PQ-48 | GOO Chemical |
| Poyquaternium-49 | PQ-49 | GOO Chemical |
| Poyquaternium-50 | PQ-50 | GOO Chemical |
| Polyvinylpyrrolidone-K30 | PVP | Sinopharm |
| | | Chemical |
| | | Reagent |
| Poly(L-lysine) | PLL | Beijing ShiJi |
| | | WenCai |
| | | Technology |
| Chitosan (molecule weight 3k) | CHI | Aldrich |
| Poly(diallyldimethylammonium chloride) | PDDA | Aldrich |
| Merquat Plus 3330 (Polyquaternium-39) | PQ-39 | Lubrizol |
| Polyhexamethylene biguanidine | PHBH | Suning |
| hydrochloride | | chemicals |
| Poly(styrene sulfonic acid) sodium salt | PSS | Alfa Asear |
| (molecular weight: ~70,000) | | |
| Heparin sodium (Lot#: 63007101) | HEP | Wokai |
| Poly(acrylic acid), sodium salt | PAA | Polysciences |
| (Molecular weight: ~60,000) | | |
| Carboxymethyl cellulose sodium salt | CMC | Acros |
| (Molecular weight: ~90,000) | | |
| Sodium alginate (Lot#: 4502229437) | ALG | Danisco |
| Poly(vinylsulfonic acid, sodium salt) | PVS | Aldrich |
| Poly(methacrylic acid) | PMA | Polysciences |
| (molecular weight: ~100,000) | | |
| Gum Arabic powder (Lot#: 69012480) | GAP | Sinopharm |

TABLE 2
Composition of model perfume, showing
ingredient, supplier and amount

| | Amount (wt % of total | |
|---|---|---|
| Ingredient | perfume composition) | Supplier |
| Linalool | 60% | Fluka |
| Benzyl acetate | 30% | TCI |
| Limonene | 10% | TCI |

### Example 1

This example demonstrates the effect of cationic polymer layer on fragrance encapsulation and release performance.

### a) Preparation of Fabric Conditioners and Liquid Laundry Detergents.

A model fabric conditioner and a model liquid laundry detergent were formulated by following standard procedures. The model fabric conditioners with pH value of 2.9 contained 3.9 wt % of unsaturated TEA quaternary ammonium (Stepantex SP88-2 ex. Stepan), 0.57 wt % of cetearyl alcohol, and was balanced by water. The model liquid laundry detergent contained 11.2 wt % of linear alkylbenzene sulfonic acid, 8.4 wt % of NEODOL 25-7 (from Shell), 8.4 wt % of sodium lauryl ether sulfate (3EO), 8.0 wt % of monopropylene glycol, and was balanced by water.

The diluted fabric conditioner and diluted liquid laundry detergent were prepared by diluting the model fabric conditioner and the model liquid laundry detergent 600 times respectively.

### b) Preparation of Perfume Delivery Microcapsule

Porous silica microcapsules encapsulating model perfume were prepared by procedures as follows. 0.2 ml of tetraethyl orthsilicate and 1.0 ml of model perfume were premixed. Then, the premix was added into 60 g of 0.5 wt % Tween 80 solution and homogenized at 7200 rpm for 20 minutes at room temperature. The pH value of the mixture was adjusted and maintained at about 3 and left to cure under stirring of 200 rpm overnight. The porous silica microcapsules slurry encapsulating model perfume were then obtained.

The zeta potential of silica microcapsule were measured by zeta potential analyzer (Zetasizer Nano ZS90, Malvern, USA) at 25° C. The microcapsules were dispersed in water with solid content of 50 ppm and the pH of the dispersion was adjusted to about 7 for measurement. Each test was repeated three times. The zeta potential of silica microcapsule is around −10 mV.

The porous silica microcapsules was coated by cationic polymer by procedure as follows. 0.007 g/ml of cationic polymer solution containing 0.5 M of sodium chloride was prepared and pH value of the solution was adjusted to 3. Then 1 ml of the cationic polymer solution was added with a speed of 0.2 ml/min into 6 ml of above silica microcapsule slurry under stirring of 200 rpm. The mixture was further stirred at room temperature overnight to obtain cationic polymer coated silica microcapsule.

### c) Perfume Leakage Evaluation

The perfume leakages were evaluated in different laundry compositions to mimic the washing/conditioning process. Microcapsule slurry containing 20 μl of model perfume was added into 2.0 g of one laundry composition in a glass vial to form a mixture. The glass vial was rolled under 30 rpm for 5 minutes. Then the mixture was filtered using membrane filter with diameter of 1.2 μm. 5.0 ml of acetone was used to extract the model perfume in 0.1 g of filtrate. The amount of extracted model perfume (A1) from the mixture in acetone liquor was measured by gas chromatography-mass spectrometry method. The perfume leakage amount (A2) was also measured by following the same procedure except that a mixture of 20 μl of model perfume with water in same amount of microcapsule slurry was used instead of microcapsule slurry.

The perfume leakage in certain laundry compositions were calculated by A1/A2×100%. The values were obtained by averaging five test results and expressed in average±standard deviation. For free perfume, the value means [1±(standard deviation of A2)/average of A2]×100%. The results were shown in Table 3.

TABLE 3

| | Perfume leakage (%) | | | |
|---|---|---|---|---|
| | | Diluted | liquid | Diluted liquid |
| | Fabric | fabric | laundry | laundry |
| Sample | conditioner | conditioner | detergent | detergent |
| Free perfume | 100.0 ± 0.2 | 100.0 ± 0.2 | 100.0 ± 0.2 | 100.0 ± 5.0 |
| Silica | 97.1 ± 10.0 | 88.8 ± 0.2 | 88.1 ± 2.0 | 104.6 ± 3.0 |
| Silica-PAH | 82.6 ± 13.3 | 77.8 ± 0.4 | 67.5 ± 7.0 | 89.7 ± 0.4 |
| Silica-PEI | 83.7 ± 15.6 | 80.7 ± 9.4 | 74.3 ± 3.0 | 82.3 ± 2.0 |
| Silica-PQ-48 | 79.6 ± 7.8 | 86.8 ± 5.2 | 87.6 ± 16.0 | 72.7 ± 5.0 |
| Silica-PQ-49 | 91.8 ± 5.6 | 73.4 ± 7.3 | 65.3 ± 11.0 | 108.0 ± 3.0 |
| Silica-PQ-50 | 87.1 ± 1.1 | 82.4 ± 6.3 | 90.0 ± 2.0 | 80.2 ± 4.0 |
| Silica-PVP | 65.9 ± 2.2 | 92.6 ± 13.5 | 78.7 ± 1.0 | 59.9 ± 1.4 |
| Silica-PLL | 82.1 ± 6.7 | 77.8 ± 3.8 | 73.1 ± 0.8 | 97.8 ± 3.0 |
| Silica-CHI | 87.1 ± 12.2 | 58.2 ± 6.3 | 74.2 ± 0.6 | 95.0 ± 8.9 |
| Silica-PDDA | 74.5 ± 7.8 | 76.6 ± 3.8 | 78.4 ± 20.0 | 96.6 ± 0.4 |
| Silica-PQ-39 | 84.6 ± 5.6 | 82.5 ± 4.6 | 61.8 ± 1.6 | 72.6 ± 0.8 |
| Silica-PHBH | 85.2 ± 1.6 | 70.4 ± 9.4 | 80.0 ± 1.0 | 83.7 ± 0.6 |

It should be noted that lower perfume leakage in the original laundry composition means better encapsulation and higher perfume leakage in the diluted laundry composition means better perfume release when washing or conditioning. Therefore, it is desirable to have a lower perfume leakage in original laundry composition but have a higher perfume leakage in the diluted laundry composition. As can be seen from Table 3, Silica-PAH, Silica-PEI, Silica-PQ-49, Silica-PLL, Silica-PDDA, Silica-PQ-39, Silica-PHBH had good performance in both fabric conditioner and laundry liquid detergent. Silica-PQ-49 had the best performance in laundry liquid detergent.

### Example 2

This example demonstrates the effect of anionic polymer on fragrance encapsulation and release performance.

### a) Preparation of Fabric Conditioners and Liquid Laundry Detergents.

The fabric conditioners and liquid laundry detergents were prepared in the same manner as described in Example 1a).

### b) Preparation of Perfume Delivery Microcapsule

Melamine-formaldehyde (MF) microcapsules encapsulating model perfume were prepared by procedures as follows. 0.533 g of 10 wt % of melamine-formaldehyde aqueous dispersion (from Wuhan Huake New Material Co., LTD) and 20 μl of model perfume were mixed under stirring of 500 rpm for 15 minutes and then stayed overnight to obtain perfume containing MF microcapsules slurry. The zeta potential of the MF was measured to be around +10 mV using same method of Example 1.

Then the MF microcapsule was coated by anionic polymer by procedure as follows. The MF microcapsules slurry was mixed with 1 ml of 5.33 mg/ml anionic polymer water dispersion under stirring to obtain anionic polymer coated MF microcapsule which encapsulated model perfume inside.

### c) Perfume Leakage Evaluation

The perfume leakage was tested in the same manner as described in Example 1c) except that the perfume delivery microcapsules used here were microcapsule prepared in example 2b). The results were obtained by averaging five test results and expressed in the same manner as Example 1 and shown in Table 4.

TABLE 4

| | Perfume leakage (%) | | | |
|---|---|---|---|---|
| | Model | Diluted model | liquid | Diluted liquid |
| | fabric | fabric | laundry | laundry |
| Samples | conditioner | conditioner | detergent | detergent |
| Free | 100.0 ± 6.0 | 100.0 ± 7.0 | 100.0 ± 19.6 | 100.0 ± 5.1 |
| perfume | | | | |
| MF | 80.7 ± 6.8 | 108.1 ± 2.4 | 89.8 ± 6.9 | 93.6 ± 3.5 |
| MF-PSS | 32.4 ± 0.9 | 109.1 ± 11.0 | 75.7 ± 22.5 | 103.8 ± 9.2 |
| MF-HEP | 30.1 ± 1.7 | 111.4 ± 0.6 | 71.4 ± 20.6 | 95.4 ± 4.2 |
| MF-PAA | 32.0 ± 0.9 | 115.3 ± 4.6 | 74.8 ± 15.7 | 93.8 ± 3.2 |
| MF-CMC | 29.7 ± 4.3 | 114.7 ± 5.0 | 76.2 ± 2.0 | 67.3 ± 4.4 |
| MF-ALG | 41.7 ± 0.9 | 109.1 ± 9.6 | 80.1 ± 3.5 | 87.5 ± 0.4 |
| MF-PVS | 31.9 ± 0.2 | 106.4 ± 2.0 | 86.8 ± 5.1 | 100.5 ± 10.6 |
| MF-PMA | 32.2 ± 4.3 | 108.1 ± 2.0 | 89.8 ± 10.8 | 83.0 ± 0.2 |
| MF-GAP | 39.5 ± 0.3 | 120.7 ± 7.6 | 86.5 ± 9.8 | 91.2 ± 4.1 |

As can be seen from Table 4, all particles have good performance for fabric conditioner. MF-PSS, MF-HEP, MF-PAA, MF-ALG had better performance in liquid laundry detergent.

### Example 3

This example demonstrates the effect of layers on fragrance encapsulation and release performance.

### a) Preparation of Liquid Laundry Detergents and Porous Silica Microcapsules

The liquid laundry detergents and the porous silica microcapsules slurry encapsulating model perfume were prepared in the same manner as described in Example 1.

### b) Coating of Cationic Polymer and Anionic Polymer

The porous silica microcapsules were coated by cationic polymer and anionic polymer by procedure as follows. 0.5 ml of PQ-49 aqueous solution (14 mg/mL) was dropped into 5 ml of silica microcapsules slurry under stirring of 200 rpm with a dosing speed of 0.25 ml/min. After continuous stirring of 200 rpm for 1 hour, then porous silica microcapsules coated by one layer of cationic polymer. Then, 0.5 ml of PSS aqueous solution (14 mg/mL) was dropped into the cationic polymer coated silica microcapsule slurry under stirring of 200 rpm with a dosing speed of 0.25 ml/min. The mixture was then stirred at 200 rpm for another 1 hour to get PSS layer coated. The coating process was repeated accordingly to get the desired polymer layers.

The zeta potential of the microcapsules was tested by following the same method as described in Example 1.

### c) Perfume Leakage Evaluation

The perfume leakage was tested in the same manner as described in Example 1c) except that the perfume delivery microcapsules used here were microcapsule prepared in example 3. The results were obtained by averaging five test results and expressed in the same manner as Example 1 and shown in Table 5.

TABLE 5

| | | Perfume leakage (%) | |
|---|---|---|---|
| | Zeta | | Diluted liquid |
| | Potential | liquid laundry | laundry |
| Samples | (mv) | detergent | detergent |
| Free perfume | — | 100.0 ± 6.5 | 100.0 ± 4.2 |
| Silica microcapsule | −13 | 89.9 ± 0.1 | 68.7 ± 8.8 |
| Silica-(PQ-49) | +37 | 93.3 ± 9.9 | 52.5 ± 5.2 |
| Silica-(PQ-49)-PSS | −21 | 84.8 ± 3.4 | 68.0 ± 6.3 |
| Silica-PQ-49-PSS-PQ-49 | +26 | 77.2 ± 11.6 | 37.6 ± 6.4 |
| Silica-(PQ-49-PSS)₂ | −25 | 52.7 ± 4.6 | 65.5 ± 8.2 |
| Silica-(PQ-49-PSS)₂-PQ-49 | +15 | 50.5 ± 14.0 | 44.2 ± 7.7 |

As can be seen from Table 5, Silica-(PQ-49)-PSS, Silica-PQ-49-PSS-PQ-49, Silica-(PQ-49-PSS)₂, Silica-(PQ-49-PSS)₂-PQ-49 performed better than the silica microcapsule in liquid laundry detergent.

### Example 4

This example demonstrates the performance of the microcapsules of the present invention.

### a) Preparation of Washing Liquid.

A washing liquid was formulated by following standard procedures. The washing liquid contained 0.00847 wt % of NEODOL 25-7 (from Shell), 0.0847 of wt % of dodecyl benzenesulfonic acid, 0.755 wt % of sodium carbonate, 0.242 wt % of sodium hydrogen carbonate, 0.23 wt % of sodium sulphate, and was balanced by water.

### b) Preparation of MF Microcapsule Containing Perfume

7.7 g of 37% of aqueous formaldehyde solution was dissolved in 44 g of DI water. The pH was adjusted to 8.9 using sodium carbonate. Then 3.9 g of melamine and 0.25 g of sodium chloride were added. The mixture was stirred at room temperature (about 20° C.) for 10 minutes and then heated to 62° C. under continuous stirring until the mixture turned clear, which indicated that the methylolation reaction was finished. The end product (called as pre-polymer solution) was an aqueous solution of a complex mixture of melamine methylolated to various degrees with solids content of 23.2 wt %.

130.7 g water was added to the pre-polymer solution and then heated to 75° C. The pH of the solution was quickly adjusted to 4.1 using formic acid and then was homogenized at 6000 to 7000 rpm. 20.3 ml of commercial perfume was added within 10 seconds and the mixture was homogenized at 6000 to 7000 rpm for 8 minutes followed by stirring at 400 at 75° C. for 3 hours and cooled naturally under stirring. Finally, the pH value of the mixture was adjusted to 7 by sodium carbonate.

The experimental microcapsule solids were measured to be 13.8% and the perfume content 10.4%.

c) Grafting of Xyloglucan (Xgl) onto the MF Capsule

60 g of MF capsule slurry (with 15% of solid content) was mixed with 18.6 g of 1% of xyloglucan aqueous solution, and 13 g of DI water was further added. The mixture was then heated and maintained at 75° C. 1.2 g of pre-polymer solution was added subsequently, then the pH was adjusted to 4 by formic acid with continuous stirring at 400 rpm at 75° C. for 3 hours. The mixture was cooled naturally under stirring and final pH value was adjusted to 7 by sodium carbonate.

Xyloglucan was also grafted onto commercial MF capsule (Asteroid Cap Det B71, Givauden) by a similar manner.

### d) Layer by Layer Coating of Cationic Polymer and Anionic Polymer

The coatings of cationic polymer and anionic polymer were conducted in a similar manner as described in Example 3b, except that the concentrations of polymer solutions was 10 mg/ml, and the solvent contained 0.5M NaCl.

### e) Perfume Delivery Evaluation

Four pieces of cotton sheets (4 cm×4 cm) were washed by 12.5 ml of washing liquid (which contains 0.1% of capsule, 5 ml was taken separately and marked as “WLB”) in a machine (SDL Atlas M228 Rotawash colorfastness tester Machine (Rock Hill, USA).) at 40° C. for 40 minutes. Then, 5 ml of water was take out and marked as “WLM” and the remaining washing liquid was removed. The cotton sheets were clenched by hand to remove excess liquor and put back to the machine and washed by 12.5 ml of DI water at 40° C. for 10 minutes. 5 ml of water was take out and marked as “WLR”.

The turbidity of samples of WLB, WLM and WLR was measured by an UV-Vis spectrophotometer (Cary 100, Agilent) with a wavelength of 400 nm. The deposition ratio was calculated by (Turbidity_{WLB}−Turbidity_{WLM}−Turbidity_{WLR}R)/Turbidity_{WLB}×100%.

On parallel, the cotton sheets were washed in the same manner and clenched to remove the excess water. Then, the perfume intensity of the cotton sheets were evaluated by Headspace Gas Chromatography-Mass Spectrometry method. The results were obtained by averaging five test results and expressed in the same manner as Example 1 and shown in Table 6.

TABLE 6

| | Depo- | Perfume delivery | | |
|---|---|---|---|---|
| | sition | Tetra- | Delta | |
| Microcapsule | ratio | hydrolinalool | Damascibe | Lilial |
| Commercial MF-xgl | 30.0 | 100.0 ± 10.0 | 100.0 ± 10.0 | 100.0 ± 5.5 |
| MF-(PSS-PQ-49)₂- | 44.2 | 38.7 ± 6.5 | 246.4 ± 25.7 | 158.5 ± 23.3 |
| xgl | | | | |

### Example 5

This example demonstrates the performance of the microcapsules of the present invention in consumer test.

The preparation of microcapsules (MF-xgl and MF-(PSS-PQ-49)₂-xgl) was conducted in the same manner as Example 4 except that MF was made in house for both particles.

The microcapsules performance test was conducted as a blind panel test in a straight comparison, with the consumer making a vote on perfume intensity of cotton sheets washed by either formulation containing the control microcapsule (MF-xgl) or same formulation but containing the microcapsule (MF-(PSS-PQ-49)₂-xgl) according to the invention.

The consumers were free to choose which has stronger perfume, and the results were shown in Table 7.

TABLE 7

| | Number of votes | | |
|---|---|---|---|
| | 0 min after | 40 min after | 1 day after |
| Microcapsule | wash | wash | wash |
| MF-xgl | 5 | 0 | 0 |
| MF-(PSS-PQ-49)₂-xgl | 19 | 24 | 24 |

1. A microcapsule comprising:
a) a benefit agent inside a water insoluble porous inner shell;
b) an outer shell comprising at least one layer of cationic polymer and at least one layer of anionic polymer; and
c) a non-ionic polysaccharide deposition aid.

2. The microcapsule according to claim 1 wherein the microcapsule has an average size of from 0.6 to 40 μm.

3. The microcapsule according to claim 1 wherein the porous inner shell has a pore with an average size of 5 nm to 500 nm.

4. The microcapsule according to claim 1 wherein the porous inner shell comprises melamine-formaldehyde, silica or a mixture thereof.

5. The microcapsule according to claim 1 wherein the cationic polymer is selected from polyallylamine hydrochloride, poly(ethyleneimine), polyquaternium-49, poly(L-lysine), poly(diallyldimethylammonium chloride), polyquaternium-39, and polyhexamethylene biguanidine hydrochloride.

6. The microcapsule according to claim 1 wherein the cationic polymer has a weight average molecular weight of from 10,000 to 400,000.

7. The microcapsule according to claim 1 wherein the anionic polymer is selected from poly-styrenesulfonic acid, heparin, polyacrylic acid, and alginate.

8. The microcapsule according to claim 1 wherein the anionic polymer has a weight average molecular weight of from 10,000 to 300,000.

9. The microcapsule according to claim 1 wherein the benefit agent is fragrance.

10. The microcapsule according to claim 1 wherein the outer shell comprises 1 to 10 layers of cationic polymer and 1 to 10 layers of anionic polymer.

11. The microcapsule according to claim 1 wherein the deposition aid is bonded to the inner shell.

12. A process for producing the microcapsule of claim 1, the process comprising:
i) encapsulating the benefit agent into a water insoluble porous inner shell;
ii) attaching a non-ionic polysaccharide deposition aid onto the microcapsule;
iii) forming a cationic polymer layer and an anionic polymer layer without a step of separation; and
optionally repeating step (iii) without a step of separation.

13. A laundry or personal care composition comprising:
a) microcapsule according to claim 1, and
b) at least one surfactant.
